(19) United States
(12) Patent Application Publication
(10) Pub. No.: US 2025/0283366 A1
(43) Pub. Date: Sep. 11, 2025

(54) ARRANGEMENT FOR MOVING AT LEAST ONE COVERING ELEMENT

(71) Applicant: Julius Blum GmbH, Hoechst (AT)

(72) Inventor: Stefan DUER, Schwarzach (AT)

(21) Appl. No.: 19/215,767

(22) Filed: May 22, 2025

Related U.S. Application Data
(63) Continuation of application No. PCT/AT2023/060379, filed on Nov. 9, 2023.

(30) Foreign Application Priority Data
Nov. 30, 2022 (AT) A 50910/2022

(51) Int. Cl. E05D 15/58; E05F 3/20; E05F 7/00

(52) U.S. Cl. CPC E05D 15/581; E05F 3/20; E05F 7/005; E05Y 2900/212

(57) ABSTRACT

An arrangement has a guide device within a cavity of a furniture part, a support to be moved along the guide device, and a pivoting device. The covering element can be mounted so as to be pivotable on the support by the pivoting device. The arrangement has a stabilizing device by which the covering element, during a movement along the guide device, can be held at a predetermined distance from the guide device and/or from a wall of the fixed furniture part. The wall delimits the cavity, wherein the stabilizing device comprises a coupling element which to be coupled to the covering element in each position of the covering element.

The present application is a continuation of International Application PCT/AT2023/060379 filed on Nov. 9, 2023. Thus, all of the subject matter of International Application PCT/AT2023/060379 is incorporated herein by reference.

### BACKGROUND OF THE INVENTION

The present invention relates to an arrangement for moving at least one covering element.

Furthermore, the invention relates to a piece of furniture and a furniture part with such an arrangement.

Such arrangements have the task of guiding and stabilizing a covering element, such as a sliding door or folding sliding door, and are already known from the prior art.

For example, AT 524607 A1 shows an arrangement for guiding a movable piece of furniture or covering element, wherein, in addition to a guide device, a separate additional guide mechanism is provided which ensures the direct guidance of the covering element on the fixed furniture part.

The disadvantage of this solution is that this additional guide mechanism requires the covering element to be coupled to the guide mechanism and thus to the furniture part, whereby errors or problems such as jamming and/or jerking can occur during coupling.

### SUMMARY OF THE INVENTION

The task of the present invention is therefore to provide an arrangement that is an improvement on the prior art, which prevents malfunctions and ensures stable guidance of the covering element.

This task is solved by an arrangement, a piece of furniture with an arrangement, and a furniture part with an arrangement, as described below.

The improved arrangement according to the invention is an arrangement for moving at least one covering element, preferably a door or folding door, relative to a fixed furniture part, which has at least one, preferably shaft-shaped, cavity for receiving the covering element and at least one interior space which can be covered by the covering element at least in some areas. The arrangement comprises at least one guide device for translational movement of the covering element within the cavity, at least one carrier movable along the guide device, and at least one swivel device. The covering element can be mounted on the carrier by means of the swivel device so as to be pivotable about a pivot axis parallel to the carrier. The arrangement comprises at least one stabilizing device with which the covering element can be held at a predetermined distance from the guide device and/or a wall of the fixed furniture part which delimits the cavity when moving along the guide device. The stabilizing device comprises at least one coupling element which can be coupled to the covering element in every position of the covering element.

A first major advantage of the invention is that there is a permanent connection between the covering element and the furniture part, so that there is no need for any coupling or uncoupling operations and therefore no malfunctions can occur during coupling.

This means that there is a connection between the covering element and the furniture part at all times and in every position of the covering element in relation to the furniture component.

Another advantage of the invention is that, due to the continuous coupling provided by the stabilizing device, the distance between the covering element and the furniture part, in particular the distance between the covering element and a wall adjacent to the cavity of the furniture part, can be kept constant when the covering element, in particular with the carrier on which the covering element is arranged, moves along the at least one guide device.

This means that the invention enables stabilization of the covering element, whereby the stabilization counteracts tilting of the covering element in particular, and whereby the covering element is stabilized in the fully lowered position of the covering element in the cavity by means of the stabilizing device, preferably at the front or outwardly facing area of the covering element.

In other words, during its movement between a fully retracted position in the cavity and a closed position in which the covering element at least partially conceals the interior of the furniture component, the covering element is stabilized and guided.

The stabilizing device can also be regarded as a type of guide due to its partial second guide device, whereby it guides the covering element during both translational and rotational movements.

The covering element is held, in particular during its translational movement along the guide device, at a predetermined distance from the guide device and/or from the furniture part and/or from a wall of the cavity of the furniture part, wherein the distance may result from the geometry and/or design of the stabilizing device.

The immediate beneficial effects of the invention are consistently precise and stable coupling and guidance of the covering element, which in turn enables component-friendly use with low component wear and smooth and pleasant operation of the arrangement by a user.

An arrangement according to the invention can be used in already known embodiments of the prior art, such as those described in the introductory part of the description, and can be installed subsequently.

It is particularly preferred that the stabilizing device has a cavity guide which is arranged or can be arranged on a wall of the cavity and is designed to support the coupling element in a displaceable manner, in particular translatorily parallel to the direction of movement of the covering element.

Preferably, the cavity guide is designed as a rail along which the coupling element can slide in a form-fitting manner.

Preferably, the cavity guide is designed so that the coupling element can be inserted into and/or removed from the cavity guide, preferably by means of an opening, for example at one end.

It is conceivable that an opening for inserting the coupling element is only temporary, in particular for installing the stabilizing device in a piece of furniture, and/or can be covered, e.g. by means of a cover.

It is particularly preferred that the stabilizing device has at least one cavity guide stop, and the cavity guide stop in particular limits relative movement of the coupling element with respect to the cavity guide.

It is particularly preferred that the stabilizing device has at least one coupling element stop, and the coupling element stop limits in particular a relative movement of the coupling element relative to the cavity guide.

The cavity guide stop and/or the coupling element stop can also act as a kind of abutment for at least one force storage member, whereby the force storage member can be charged and/or discharged.

For example, a force storage member in the form of a spring, such as a compression spring, can be tensioned and/or relaxed by means of the cavity guide stop and/or the coupling element stop.

In a preferred embodiment of the coupling element, the coupling element has two coupling element stops.

It is particularly preferred that the stabilizing device has a covering element guide which is arranged or can be arranged on the covering element and is designed to mount the coupling element so that it can be displaced, in particular in a translational manner.

Preferably, the covering element guide is designed as a rail along which the coupling element can slide.

It is preferable for the covering element guide to be designed in such a way that the coupling element can be inserted and/or hooked into the covering element guide, preferably by means of an opening, for example at one end.

It is preferable for the covering element guide to be designed such that the coupling element, preferably in the middle of an opening, for example at one end, can be inserted and/or hooked into the covering element guide.

It is conceivable that an opening for inserting the coupling element is only temporary, in particular for installing the stabilizing device in a piece of furniture, and/or can be covered, e.g. by a cover.

It is preferable for the covering element guide to be designed so that it can be attached to the covering element, for example by a screw, snap-in, or adhesive mechanism.

It is particularly preferred that the stabilizing device has at least one covering element guide stop which limits relative movement of the coupling element relative to the covering element guide, in particular so that the coupling element cannot become unhooked and/or a force storage member can be charged and/or discharged.

In a preferred embodiment of the covering element guide, the at least one covering element guide stop is arranged at one end of the covering element guide. However, it can also be arranged at another location.

It is particularly preferred that at least one sliding element, preferably a rolling element, is provided, preferably which coupling element is designed to slide and/or roll in the cavity guide and/or the covering element guide.

It is particularly preferred that the coupling element consists of at least two coupling element parts, wherein at least two of the at least two coupling element parts are connected to each other by means of at least one hinge.

The hinge is particularly advantageous in that it allows relative rotational movement between the two coupling elements, with the axis of rotation being essentially parallel to the pivot axis of the covering element.

However, it is also conceivable that the hinge has more than one degree of freedom and/or is a ball hinge and/or a solid hinge.

It is particularly preferred that at least one of the at least two coupling element parts is a spacer element which is designed to maintain the specified distance between the covering element and the at least one guide device constant when the covering element moves along the guide device.

Preferably, the stabilizing device has at least one support element which is designed to support the coupling element, preferably the at least one spacer element of the coupling element, in such a way that the predetermined distance between the covering element and the guide device and/or the wall of the cavity is maintained when the covering element moves along the guide device.

Preferably, the support element is designed and/or arranged in such a way that the spacer element can be supported so that the specified distance is maintained.

It is particularly preferred that the stabilizing device has at least one force storage member which is designed at least to support a relative, in particular translational, movement of the coupling element for guiding the cavity and/or the covering element guide.

In a particularly preferred embodiment, the force storage member comprises a spring, in particular a compression spring, which is arranged around the coupling element and/or within the cavity guide.

Preferably, the at least one force storage member is arranged on the coupling element and/or on the cavity guide and/or on the covering element guide.

It is particularly preferred that the force member storage is arranged between the cavity guide stop of the cavity guide and at least one coupling element stop of the coupling element, in particular wherein the cavity guide stop and/or the coupling element stop serves as an abutment for the force storage member.

It is possible that the stabilizing function for at least one force storage member includes stabilizing the covering element in an intermediate position of the covering element.

It is particularly preferred that the at least one force storage member has a locking function for locking the covering element in a closed position of the covering element.

It is possible that the at least one force storage member has a damping function for damping the movement of the coupling element.

It is particularly preferred that the at least one force storage member has a return effect on the covering element in the direction of a fully retracted position of the covering element.

Furthermore, protection is sought for a piece of furniture with at least one covering element, preferably a door or folding door, at least one fixed furniture part, which has at least one, preferably shaft-shaped, cavity for receiving the covering element and at least one interior space, which can be covered at least in part by the covering element. The piece of furniture has at least one arrangement as noted above for moving at least one covering element relative to the at least one furniture part.

In addition, protection is sought for a furniture part with at least one, preferably shaft-shaped, cavity for receiving a covering element, preferably a door or folding door, at least one interior space which can be covered by the covering element at least in some areas, and an arrangement as noted above for moving the covering element relative to the furniture part.

It is particularly preferred that the stabilizing device is arranged essentially in the middle and/or the upper half of the furniture part and/or the covering element so that the stabilizing device optimally counteracts the tilting of the covering element.

Preferably, the furniture part has a further compensation device for compensating a tilting moment of the carrier or of the covering element arranged thereon. Preferably, the compensation device has at least one cable pull device and/or a pivot lever mechanism.

### BRIEF DESCRIPTION OF THE DRAWINGS

Further advantages and details of the invention will be apparent from the drawings, in which:

FIG. 1-2 are views of a first embodiment of an arrangement in an intermediate position of the covering element,

FIG. 3-4 are views of the first embodiment of an arrangement in a closed position of the covering element,

FIG. 5-6 are views of a first embodiment of a stabilizing device,

FIG. 7-13 show a sequence of movements of the first embodiment of an arrangement or of the first embodiment of a stabilizing device,

FIG. 14-17 show a sequence of movements of a second embodiment of an arrangement or a second embodiment of a stabilizing device,

FIG. 18-20 are views of a second embodiment of an arrangement in a closed position of the covering element,

FIG. 21-26 are views of the third embodiment of a stabilizing device, and

FIG. 27-33 show a sequence of movements of the second embodiment of an arrangement or a third embodiment of a stabilizing device.

### DETAILED DESCRIPTION OF THE INVENTION

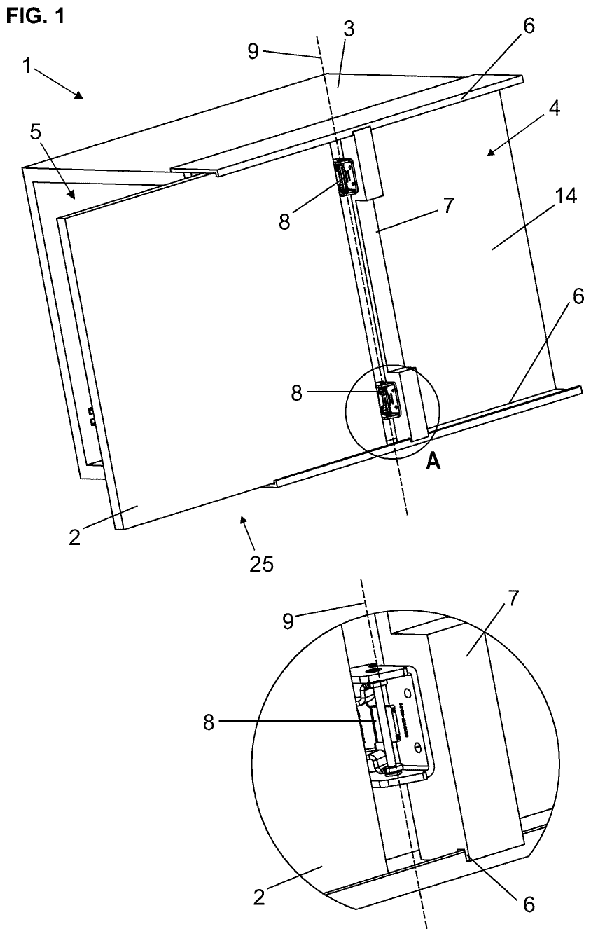

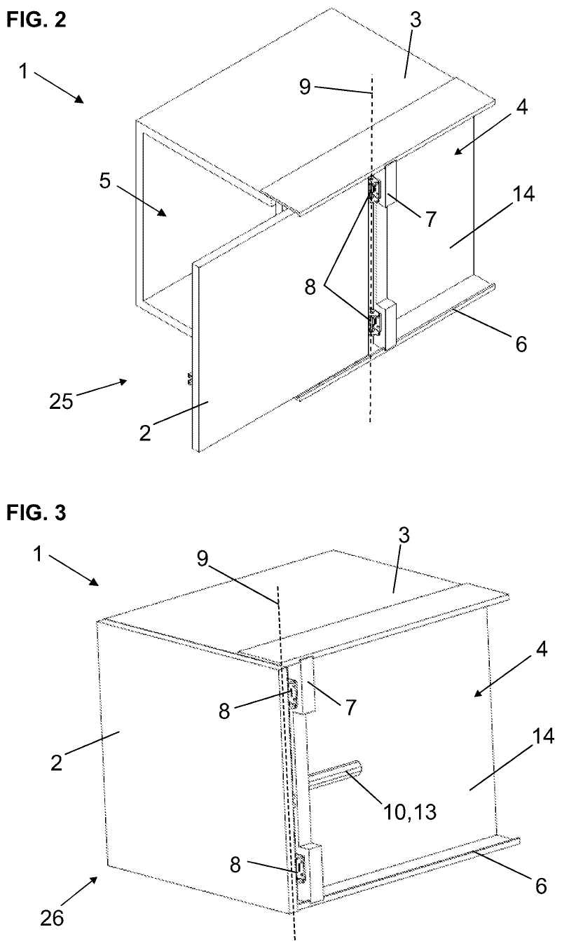

FIGS. 1 and 2 show views of a first embodiment of an arrangement 1 in an intermediate position 25 of the covering element 2, wherein FIG. 1 additionally shows a detailed view of the connection point of a swivel device 8 on the carrier 7. The stabilizing device 10 is not visible in these views because it is concealed by the covering element 2.

FIG. 1 shows primarily those components that belong to the general state of the art. In particular, a furniture part 3 is shown with at least one, preferably shaft-shaped, cavity 4 for receiving a covering element 2, preferably a door or folding door, at least one interior space 5, which can be covered at least in part by the covering element 2, a guide device 6 for translational movement of the covering element 2 within the cavity 4, a carrier 7 movable along the guide device 6, two swivel devices 8 by means of which the covering element 2 is mounted on the carrier 7 so as to be pivotable about a pivot axis 9.

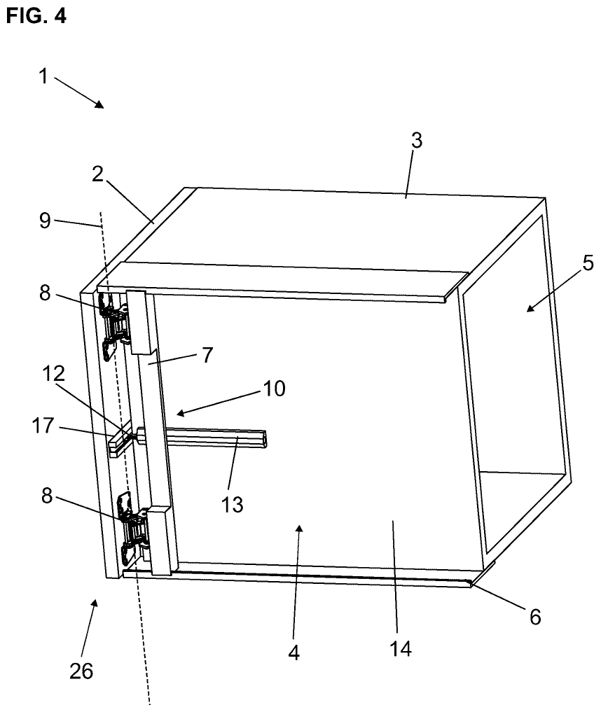

FIGS. 3 and 4 show views of the first embodiment of an arrangement 1 in a closed position 26 of the covering element 2, wherein the stabilizing device 10 is now also shown, which stabilizing device 10 comprises a coupling element 12 which is coupled to the covering element 2 in every position of the covering element 2.

FIG. 4 shows, in particular, a cavity guide 13, which is attached to a wall 14 of the shaft-shaped cavity 4, a covering element guide 17, which is attached to the covering element 2, and the coupling element 12.

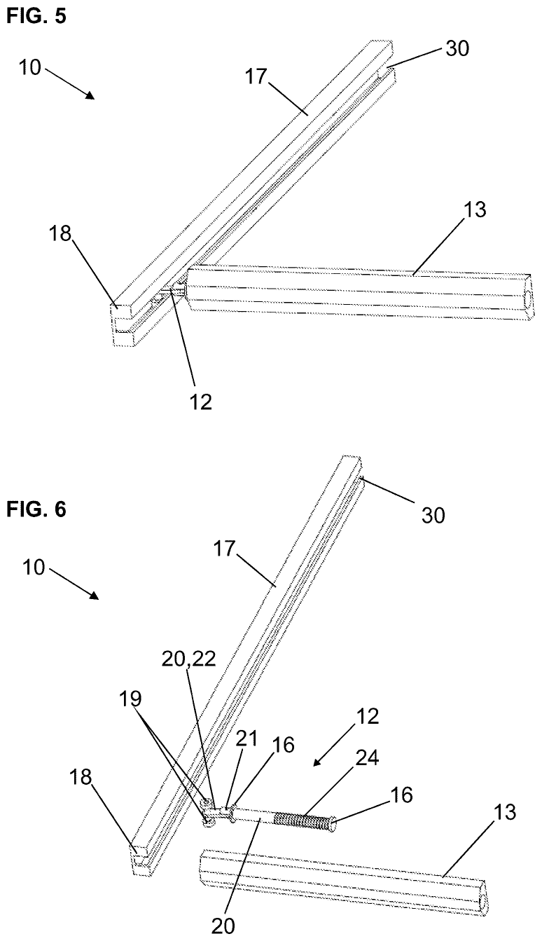

FIGS. 5 and 6 show views of a first embodiment of a stabilizing device 10, which comprises a cavity guide 13, a covering element guide 17, and a coupling element 12.

In this first embodiment of the stabilizing device 10, the covering element guide 17 has a covering element guide stop 18 which can limit relative movement of the coupling element 12 relative to the covering element guide 17.

FIG. 6 shows the cavity guide 13, the covering element guide 17, and the coupling element 12 spaced apart from each other in an exploded view so that further sub-elements of the stabilizing device 10 are also visible.

In this embodiment, the coupling element 12 has two coupling element stops 16, wherein a force storage member 24 in the form of a spring, in particular a compression spring, is arranged on one coupling element stop 16, which spring surrounds the coupling element 12.

In this embodiment, the coupling element 12 consists of two coupling element parts 20, which are connected to each other by a hinge 21.

One of the two coupling elements 20 in this embodiment is a spacer element 22, which is designed at least to maintain the specified distance 11 between the covering element 2 and the guide device 6 constant when the covering element 2 moves along the guide device 6.

In this embodiment, two sliding elements 19 in the form of rolling elements, preferably running wheels, are arranged on a coupling element part 20, in particular on the spacer element 22, which are designed to be moved along the covering element guide 17.

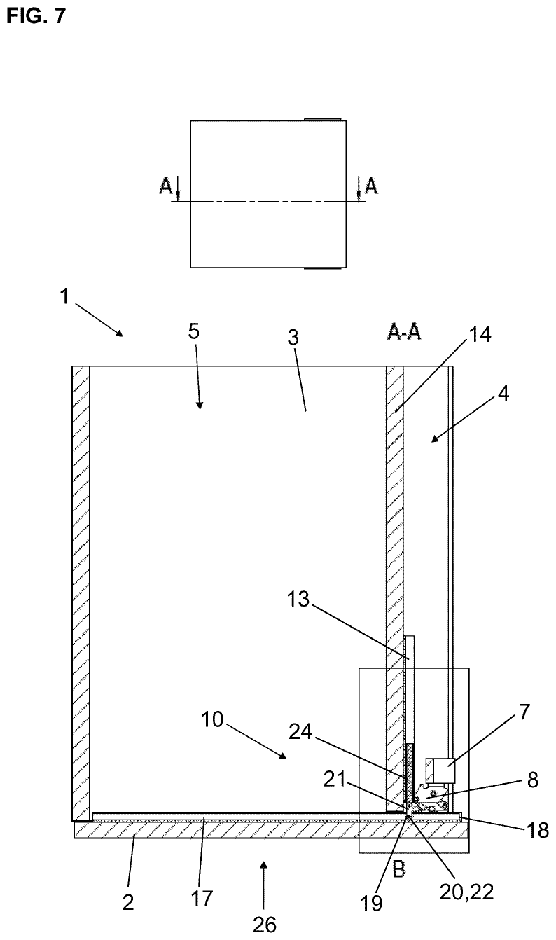

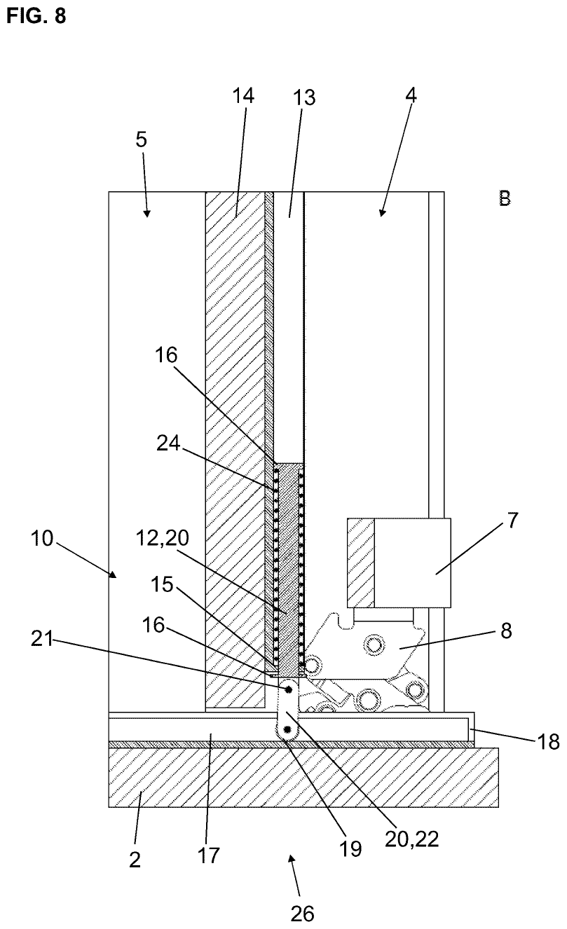

FIGS. 7-13 show horizontal sections of a sequence of movements of the first embodiment of an arrangement 1 and of the first embodiment of a stabilizing device 10, respectively. FIG. 7 shows the entire arrangement 1; FIGS. 8-13 show detailed views of the sequence of movements of the stabilizing device 10.

FIGS. 8-13 also show that the cavity guide 13 has a cavity guide stop 15 which can limit relative movement of the coupling element 12 relative to the cavity guide 13 and/or can act as an abutment for a force storage member 24, in particular by means of which abutment the force storage member 24 can be charged.

The force storage member 24 or the spring can generally support a relative, in particular translational, movement of the coupling element 12 relative to the cavity guide 13 and/or the covering element guide 17.

In FIG. 8, the covering element 2 is in the closed position 26, whereby it is completely outside the cavity 4 and at least partially covers the interior space 5 of the furniture part 3.

In closed position 26, the force storage member 24 or the spring is in a relaxed or only relatively tensioned state.

In this embodiment, the force storage member 24 is slightly preloaded in the closed position 26 so that the force storage member 24 has a locking function for locking the covering element 2 in the closed position 26.

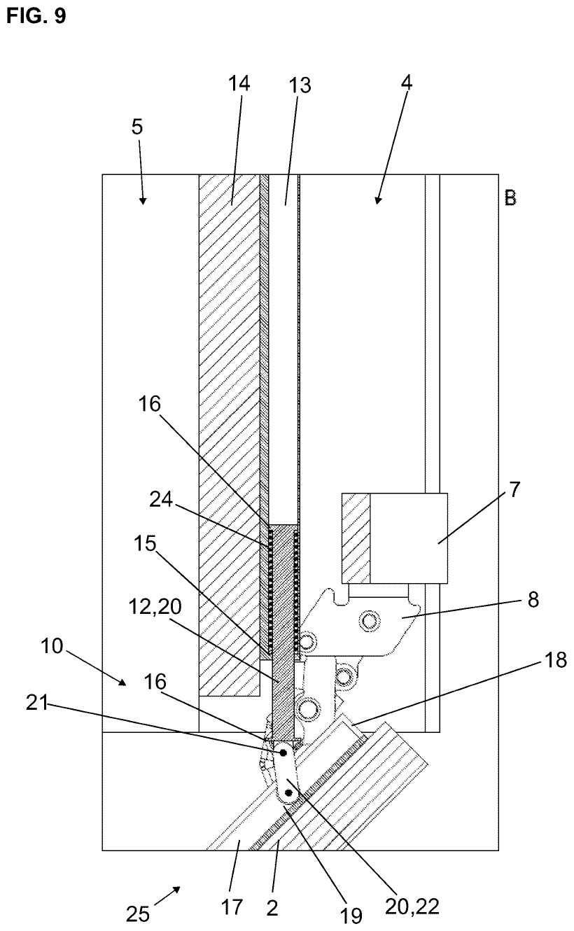

In FIG. 9, the covering element 2 is in an intermediate position 25, whereby the covering element 2 swivels about the pivot axis 9 and/or rotates about the hinge 21.

In this embodiment, the force storage member 24 is relatively strongly biased in this intermediate position 25, whereby the force storage member 24 exerts a restoring force on the covering element 2 in the direction of a fully retracted position 27 of the covering element 2.

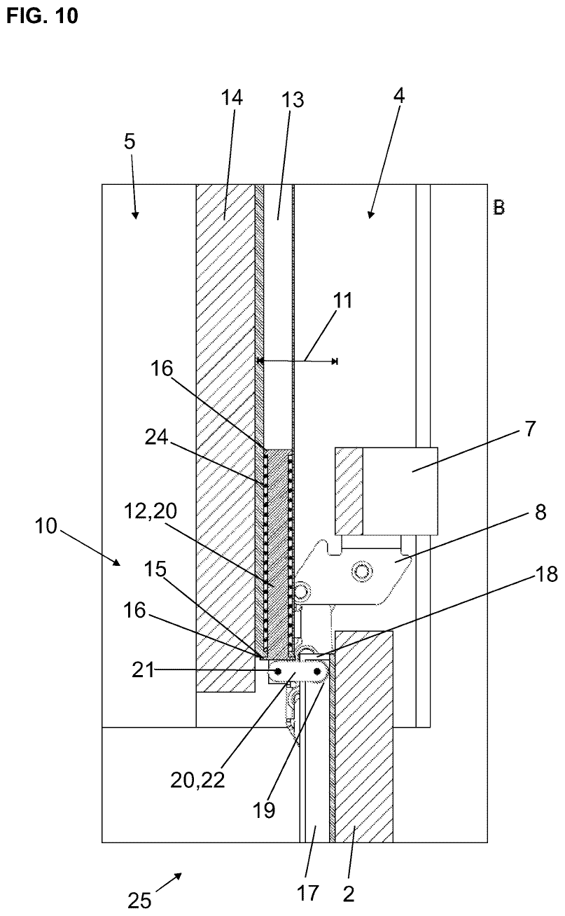

In FIG. 10, the covering element 2 is in an intermediate position 25, wherein the covering element 2 is pivoted by 90° about the pivot axis 9 and/or rotated about the hinge 21 starting from the closed position 26, so that the covering element 2 is essentially parallel to the wall 14 of the furniture part 3 or aligned with the cavity 4.

In this intermediate position 25, the coupling device 14, in particular the spacer element 22 of the coupling device 12 and/or the at least one sliding element 19, contacts the covering element guide stop 18 so that the covering element 2 is also held by the stabilizing device 10 and/or remains coupled and/or a translational movement out of the cavity 4.

In this embodiment of the stabilizing device 10, the spacer element 22 of the coupling element 12 strikes the coupling element stop 16 so that the rotation of the spacer element 22 about the hinge 21 is limited.

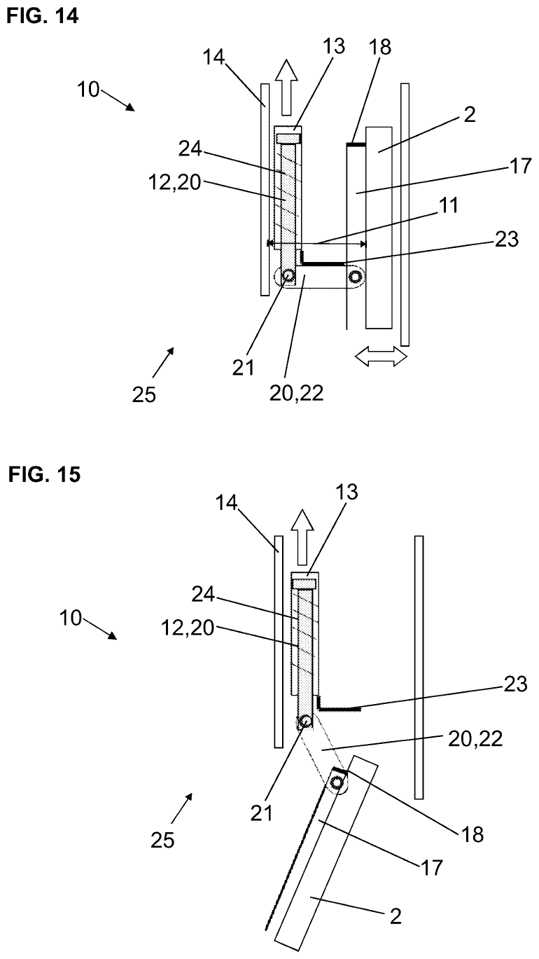

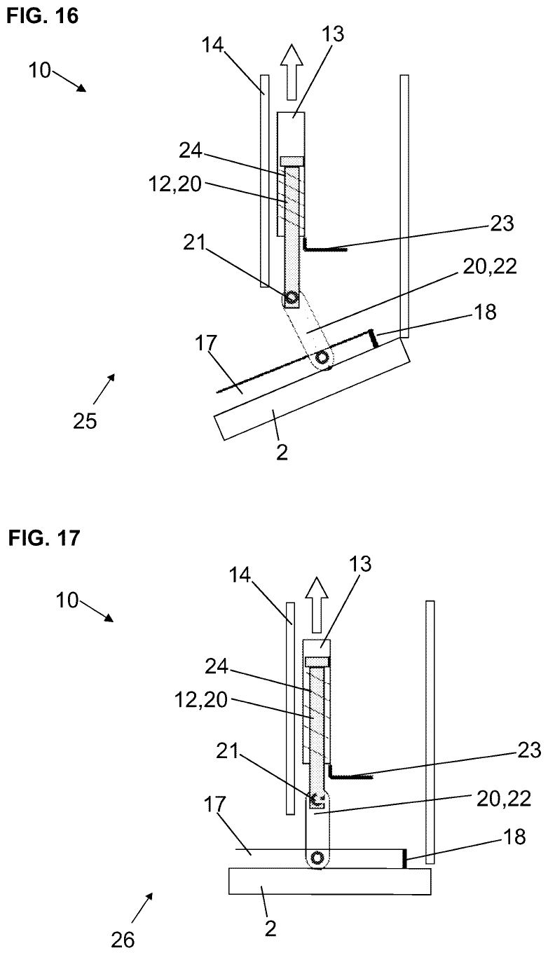

It is also conceivable that at least one additional support element 19 is provided, in particular instead of at least one coupling element stop 16. See FIGS. 14-17, where such a support element 19 is shown.

In this intermediate position 25, the cavity guide stop 15 of the cavity guide 13 and the coupling element stop 16 of the coupling element 12 closer to the covering element 2 touch each other so that no translational movement of the coupling element 12 along the cavity guide 13 takes place and/or the force storage member 24 is relaxed or only relatively slightly tensioned.

FIGS. 10-13 show the specified distance 11 between the covering element 2 and the guide device 6 and/or the wall 14 of the furniture part 3, which wall 14 adjoins the cavity 4.

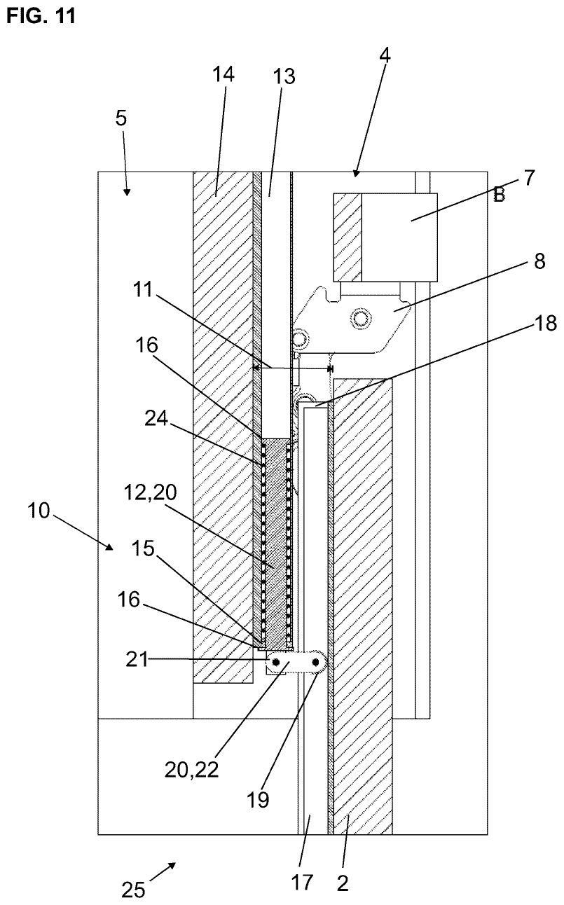

FIG. 11 shows an intermediate position 25 in which the coupling element 12 is essentially in a rest position and the covering element 2 is guided by the stabilizing device 10 further into the cavity 4 toward a fully retracted position 27.

When the covering element 2 moves toward the fully retracted position 27, the covering element 2 slides along the coupling element 12, in particular along the spacer element 22 and/or the at least one sliding element 19, by means of the covering element guide 17.

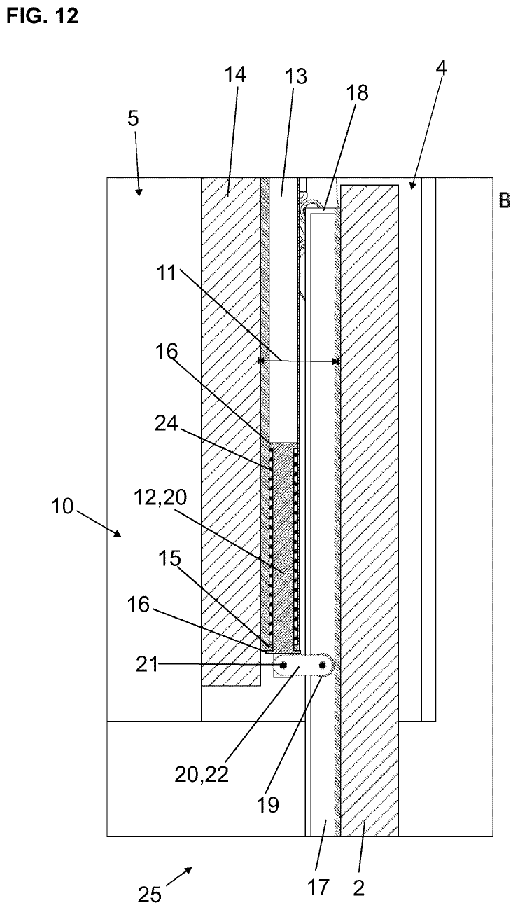

FIG. 12 shows an intermediate position 25 in which the covering element 2 is further in the cavity 4 closer to a fully retracted position 27.

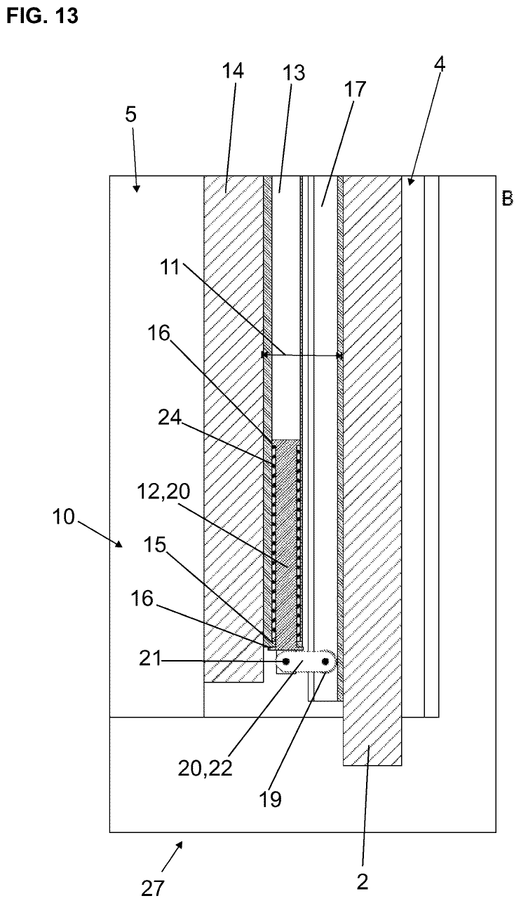

FIG. 13 essentially shows a fully retracted position 27 of the covering element 2, wherein the covering element 2 is advantageously stabilized by means of the stabilizing device 10 at the front or outwardly facing region of the covering element 2.

During the entire movement sequence of the covering element 2, the force storage member 24 can also have a damping function to dampen the movement of the covering element 2 and/or the coupling element 12.

It is also conceivable that the force storage member 24 has a stabilizing function for stabilizing the covering element 2 in an intermediate position 25.

FIG. 14-17 show horizontal sections of a sequence of movements of a second embodiment of an arrangement 1 and a second embodiment of a stabilizing device 10, respectively.

This sequence of movements essentially corresponds to the movement steps shown in FIGS. 7-13 of the first embodiment of a stabilizing device 10.

In this embodiment, however, the stabilizing device 10 has an additional support element 23, which is arranged in particular on the cavity guide 13 and limits the rotational movement of the spacer element 22 about the hinge 21.

The stabilizing device 10 and/or the support element 23 is preferably designed such that the specified distance 11 between the covering element 2 and the guide device 6 remains constant when the covering element 2 moves along the guide device 6.

As previously in the position shown in FIG. 13, in the position shown in FIG. 14, the covering element 2 is stabilized by means of the stabilizing device 10, preferably at the front or outwardly facing area of the covering element 2.

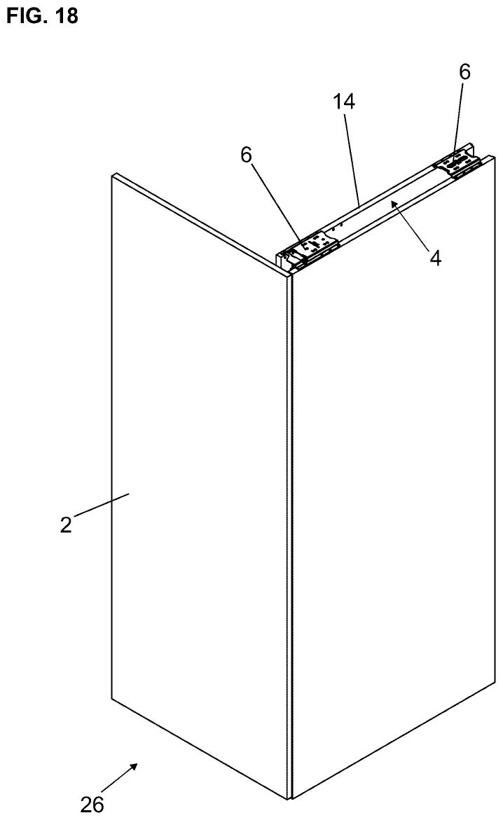

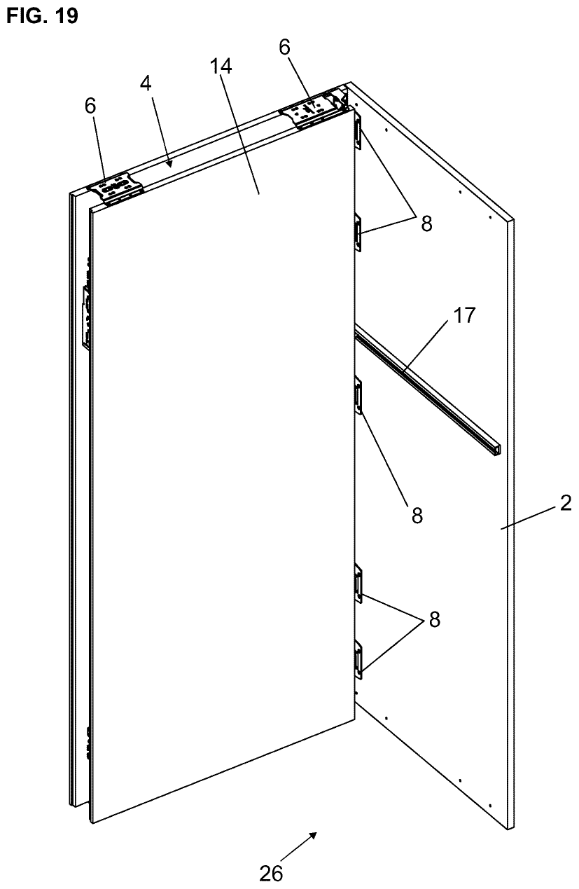

FIGS. 18-20 show views of a second embodiment of an arrangement 1 in a closed position 26 of the covering element 2.

In this second embodiment, the stabilizing device 10 is essentially located in the middle and/or upper half of the furniture part 3, in particular on a wall 14 of the cavity 4 and/or the covering element 2.

Particularly in the case of large covering elements 2, it may be helpful to arrange the stabilizing device 10 in the upper region in order to counteract the tilting moment of the covering element 2 and/or the carrier 7.

It is also conceivable to arrange several stabilizing devices 10 on the furniture part 3.

The second embodiment of an arrangement 1 has several additional elements compared to the first embodiment.

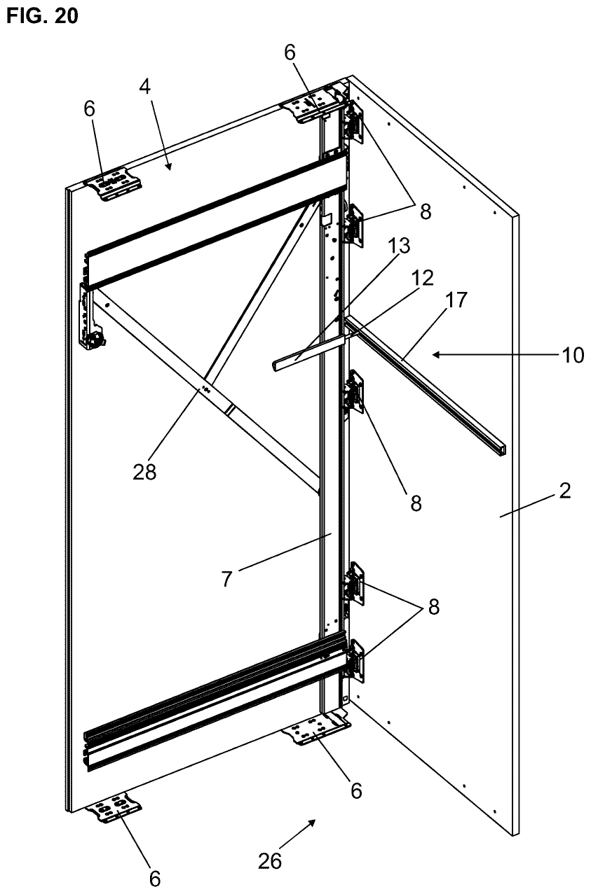

In particular, FIG. 20 shows, in addition to the stabilizing device 10, four guide devices 6, which are attached to the side edges of the cavity 4, and a further compensation device 28 for compensating a tilting moment of the carrier 7 or of the covering element 2 arranged thereon.

It is possible that the compensation device 28 has at least one cable pull device and/or a pivot lever mechanism.

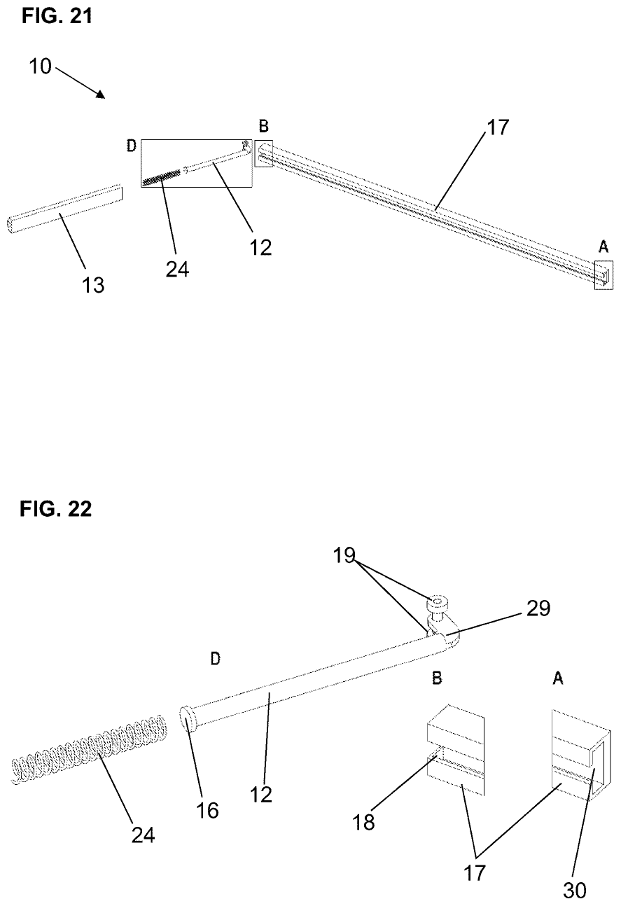

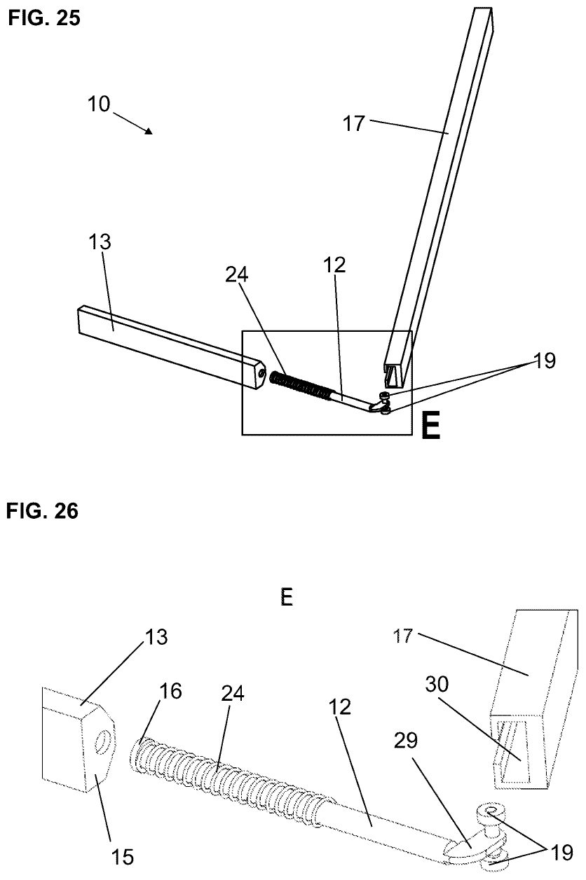

FIGS. 21-26 show views of the third embodiment of a stabilizing device 10 comprising a cavity guide 13, a covering element guide 17, and a coupling element 12.

FIG. 22 shows, in particular and in contrast to the first two embodiments of the stabilizing device 10, a substantially single-piece coupling element 2, which has a curved end 29 closer to the covering element 2.

The curved end 29 of the coupling element 12 is preferably designed in accordance with the specified distance 11.

The coupling element 2 of this embodiment of a stabilizing device 10 has a coupling element stop 16, which serves in particular as an abutment for the force storage member 24.

In this embodiment, the force storage member 24 is arranged next to the coupling element 12 and between an end of the cavity guide 13 serving as an abutment and the coupling element stop 16.

The arrangement of the force storage member 24 in this third embodiment is thus different from the first two embodiments of the stabilizing device 10, in which the force storage member 24 at least partially surrounds the coupling element 12.

Furthermore, FIG. 22 contains detailed views of the two ends of the covering element guide 17, one end having a covering element guide stop 18.

In this embodiment, one end of the covering element guide 17 has an opening 30 through which the coupling element 12 can be inserted.

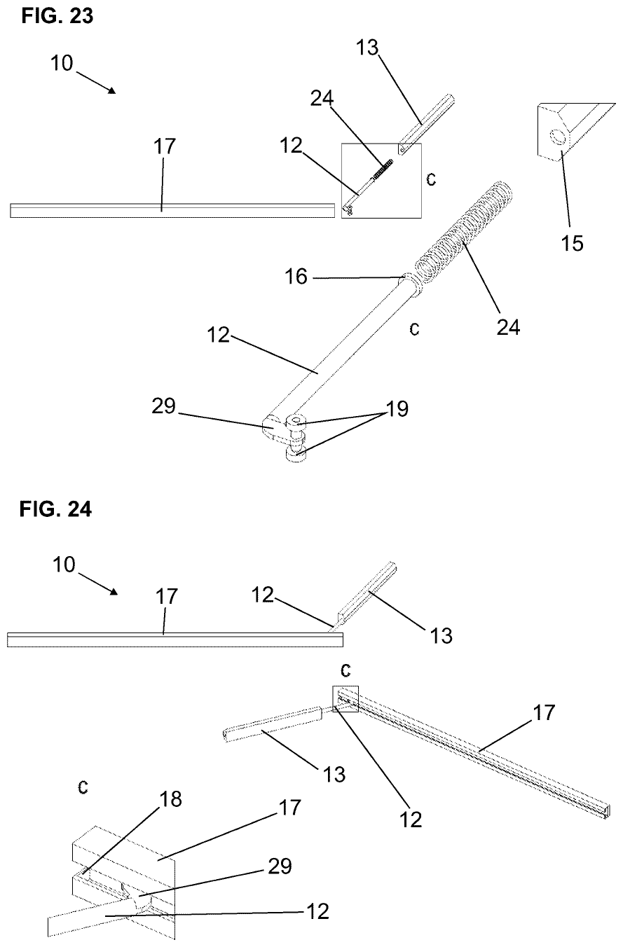

Furthermore, FIG. 23 shows a cavity guide stop 15 of the cavity guide 13, which can act as a limit for the movement of the coupling element 12 and/or as an abutment for a force storage member 24.

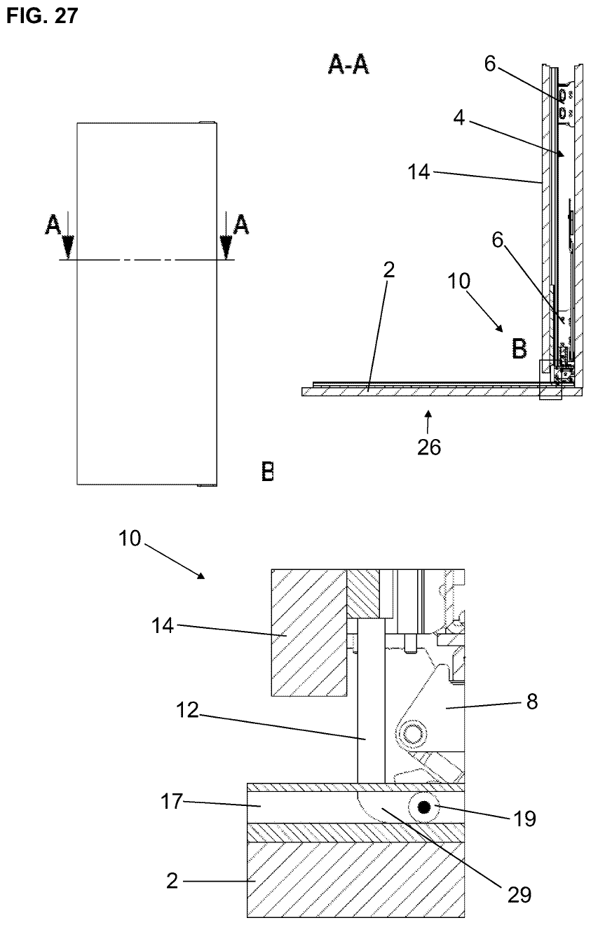

FIGS. 27-33 show a sequence of movements of the second embodiment of an arrangement 1 or a third embodiment of a stabilizing device 10, which has a curved end 29.

FIG. 27 shows a closed position 26 of the covering element 2, wherein the covering element 2 is completely outside the cavity 4.

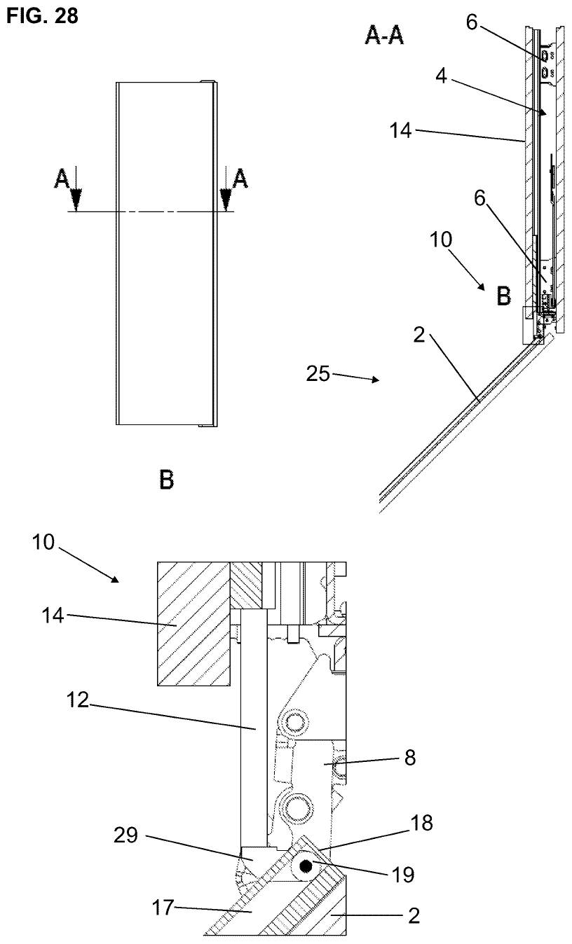

FIG. 28 shows an intermediate position 25, wherein the covering element 2 is pivoted about the pivot axis 9 and/or rotated about the curved end 29 and/or about at least one sliding element 19.

In the position shown in FIG. 28, the curved end 29 of the coupling element 12 and/or the at least one sliding element 19 touches the covering element guide stop 18 of the covering element guide 17.

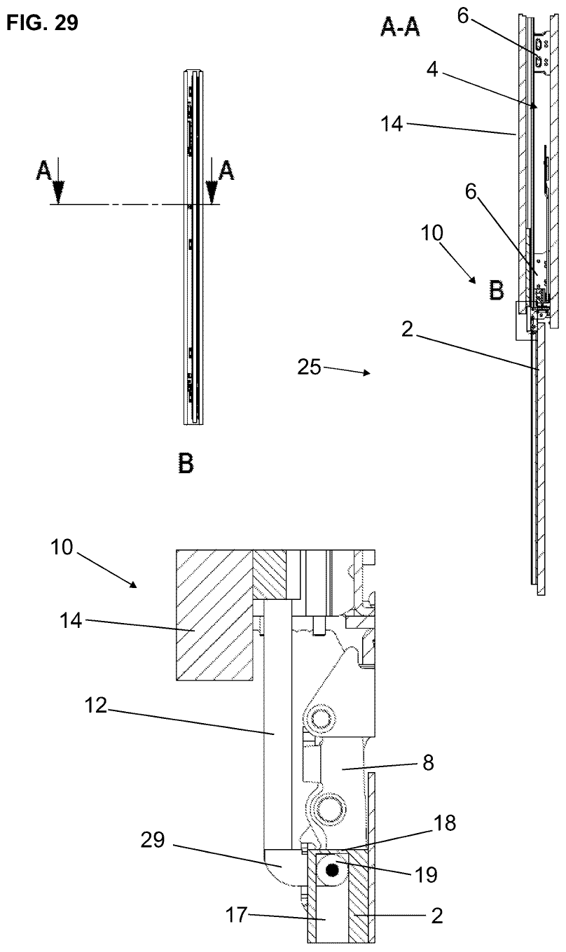

FIG. 29 shows another intermediate position 25 in which the covering element 2 is aligned parallel to the wall 14 of the furniture part 3.

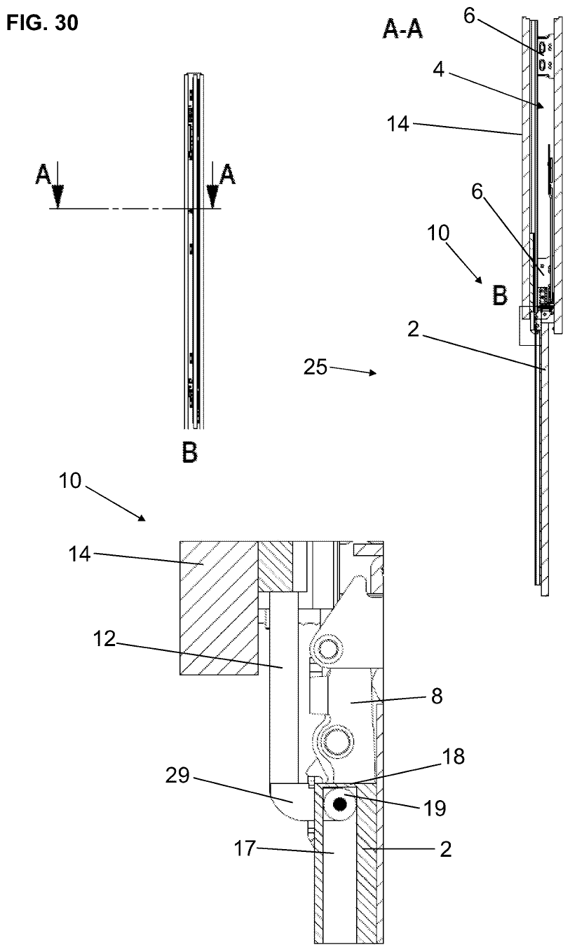

FIGS. 30-32 show two further intermediate positions 25, in which the covering element 2 moves translationally toward a fully retracted position 27 of the covering element 2 in the cavity 4.

In the position shown in FIG. 30, the coupling element 12 moves translatorily in the direction of the fully retracted position 27 into the cavity 4.

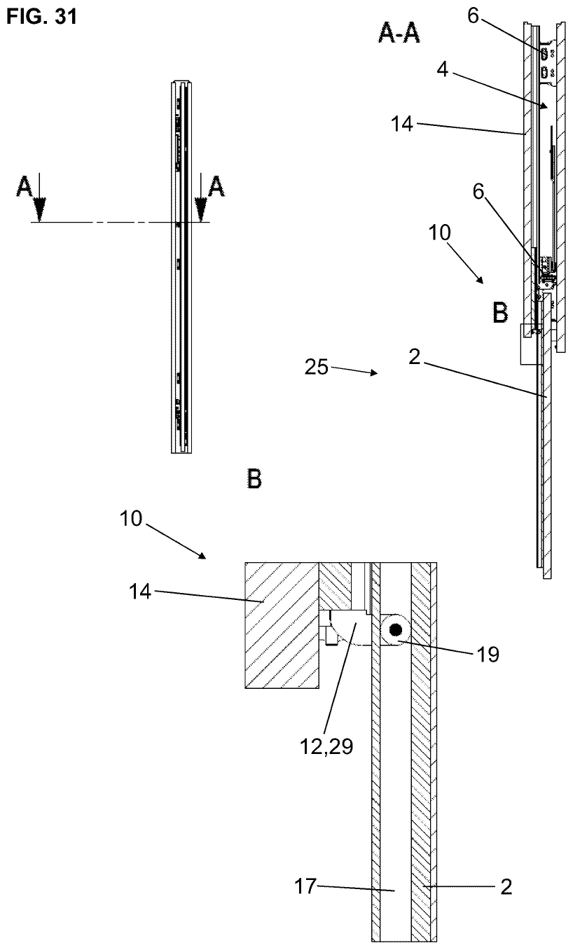

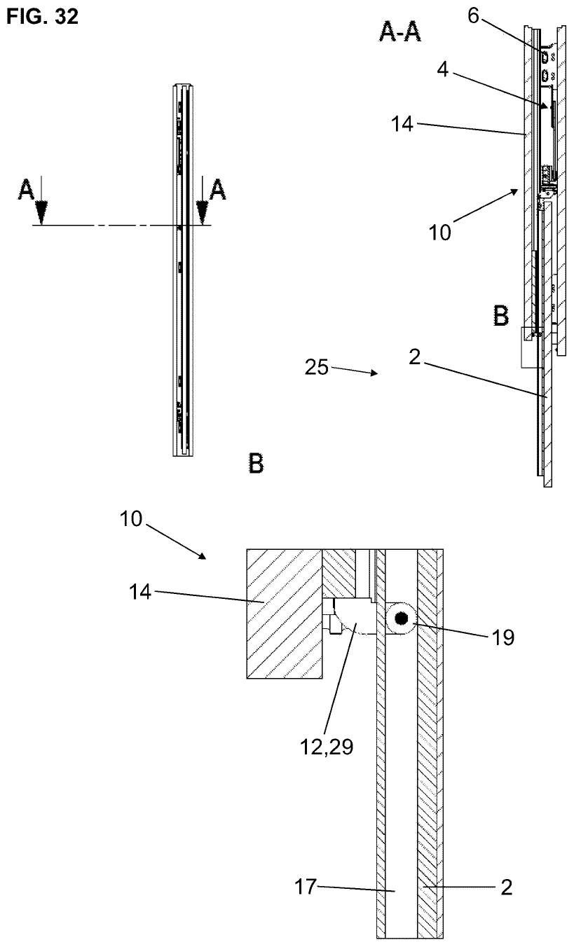

In FIGS. 31 and 32, the coupling element 12 is located in the lowest possible position against the stop in the cavity guide 13, so that only the covering element 2 moves further into the cavity 4, whereby the covering element guide 17 is guided by at least one sliding element 19 and/or the bent end 29.

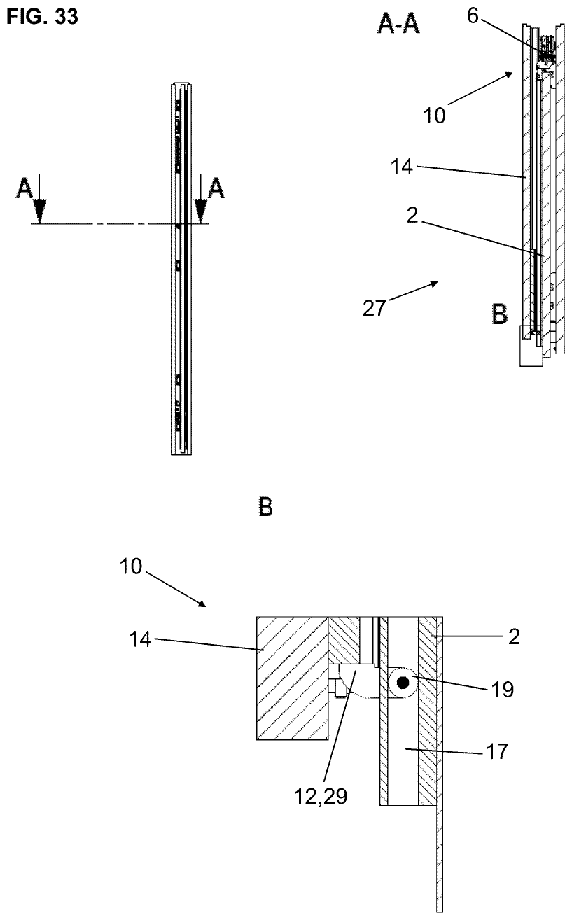

In the position shown in FIG. 33, the covering element 2 is essentially in a fully retracted position 27 within the cavity 4, whereby the covering element 2 is preferably stabilized by means of the stabilizing device 10 at the front or outwardly facing area of the covering element 2.

1. An arrangement for moving at least one covering element, preferably a door or folding door, relative to a fixed furniture part, which has at least one, preferably shaft-shaped, cavity for receiving the covering element and at least one interior space, which can be covered at least in part by the covering element, wherein the arrangement has at least one guide device for translational movement of the covering element within the cavity, at least one carrier movable along the guide device and at least one swivel device, wherein the covering element can be mounted on the carrier by means of the swivel device so as to be pivotable about a pivot axis parallel to the carrier, wherein the arrangement comprises at least one stabilizing device by means of which the covering element can be held at a predetermined distance from the guide device and/or a wall of the fixed furniture part which delimits the cavity when moving along the guide device, wherein the stabilizing device comprises at least one coupling element which can be coupled to the covering element in every position of the covering element.

2. The arrangement according to claim 1, wherein the stabilizing device has a cavity guide which is arranged or can be arranged on the wall of the cavity and is designed to support the coupling element in a displaceable manner.

3. The arrangement according to claim 1, wherein the stabilizing device has at least one cavity guide stop which limits relative movement of the coupling element to the cavity guide.

4. The arrangement according to claim 1, wherein the stabilizing device has at least one coupling element stop which limits relative movement of the coupling element relative to the cavity guide.

5. The arrangement according to claim 1, wherein the stabilizing device has a covering element guide which is arranged or can be arranged on the covering element and is designed to mount the coupling element so that it can be displaced.

6. The arrangement according to claim 1, wherein the stabilizing device has at least one covering element guide stop which limits relative movement of the coupling element to the covering element guide.

7. The arrangement according to claim 1, wherein the coupling element has at least one sliding element, preferably at least one rolling element.

8. The arrangement according to claim 1, wherein the coupling element consists of at least two coupling element parts, wherein at least two of the at least two coupling element parts are connected to each other by means of at least one hinge.

9. The arrangement according to claim 8, wherein at least one of the at least two coupling element parts is a spacer element which is designed to maintain the predetermined distance between the covering element and the guide device constant during movement of the covering element along the guide device.

10. The arrangement according to claim 1, wherein the stabilizing device has at least one support element which is designed to support the coupling element, preferably the at least one spacer element of the coupling element, in such a way that the predetermined distance between the covering element and the guide device is maintained when the covering element moves along the guide device.

11. The arrangement according to claim 1, wherein the stabilizing device has at least one force storage member which is designed at least to support a relative, in particular translational, movement of the coupling element to the cavity guide and/or the covering element guide.

12. The arrangement according to claim 11, wherein the at least one force storage member comprises at least one spring.

13. The arrangement according to claim 11, wherein the at least one force storage member is arranged:
on the coupling element, and/or
on the cavity guide, and/or
on the covering element guide.

14. The arrangement according to claim 11, wherein the at least one force storage member:
has a locking function for locking the covering element in a closed position, and/or
has a damping function for damping the movement of the coupling element, and/or
has a return effect on the covering element in the direction of a retracted position of the covering element.

15. A furniture with at least one covering element, preferably a door or folding door, at least one fixed furniture part, which has at least one, preferably shaft-shaped, cavity for receiving the covering element and at least one interior space, which can be covered at least in some areas by the covering element, wherein the furniture has at least one arrangement according to claim 1 for moving at least one covering element relative to the at least one furniture part.

16. A furniture part with at least one preferably shaft-shaped cavity for receiving a covering element, preferably a door or folding door, at least one interior space which can be covered at least in part by the covering element, and an arrangement according to claim 1 for moving the covering element relative to the furniture component.

17. The furniture part according to claim 16, wherein the stabilizing device is arranged essentially in the middle and/or the upper half of the furniture part and/or the covering element.

18. The furniture part according to claim 16, wherein the furniture part has a compensation device for compensating a tilting moment of the carrier or of the covering element arranged thereon, preferably wherein the compensation device comprises at least one cable pull device and/or a pivot lever mechanism.
